(19) United States
(12) Patent Application Publication
(10) Pub. No.: US 2017/0113349 A1
(43) Pub. Date: Apr. 27, 2017

(54) SAFETY MONITORING DEVICE FOR ROBOT

(71) Applicant: FANUC CORPORATION, Yamanashi (JP)

(72) Inventors: Yasuhiro Naitou, Yamanashi (JP); Soichi Arita, Yamanashi (JP); Hiromitsu Takahashi, Yamanashi (JP)

(73) Assignee: FANUC CORPORATION, Yamanashi (JP)

(21) Appl. No.: 15/298,876

(22) Filed: Oct. 20, 2016

(30) Foreign Application Priority Data
Oct. 21, 2015 (JP) 2015-207134

(51) Int. Cl. B25J 9/16; B25J 13/08; B25J 19/06

(52) U.S. Cl. CPC B25J 9/1674; B25J 19/06; B25J 13/085; B25J 13/088; G05B 2219/40202

(57) ABSTRACT

A safety monitoring device for a robot includes a position detecting unit for detecting the position of a robot, a force detecting unit for detecting an external force applied to the position detecting unit, an external force determination condition setting unit, which sets, as an external force determination condition, an intra-region external force determination condition when the present position of the robot detected by the position detecting unit remains within a predetermined region and which sets, as an external force determination condition, an out-of-region external force determination condition when the present position of the robot is outside of the predetermined region, and a robot stopping unit for stopping the robot when the external force detected by the force detecting unit satisfies the external force determination condition.

### BACKGROUND OF THE INVENTION

1. Field of the Invention

The present invention relates to a robot safety monitoring device for monitoring the safety of a robot by detecting external forces.

2. Description of the Related Art

Robots, which operate together with a person in the same working area without safety fences, have been widely used. Such robots have a function for detecting an external force as disclosed in Japanese Patent Nos. 4938118 and 5353656. When an external force, which has been detected when a person touches a robot, exceeds a predetermined threshold value, the robot stops, to ensure human safety.

However, depending on the type of operation performed by a person or robot, changing a threshold value of an external force may be desired in some cases. In this respect, Japanese Patent No. 5436160 discloses that, in order to efficiently perform an operation in which a robot receives a reaction force, a force limiting parameter is switched to another parameter at a designated location on the trajectory of motion receiving a reaction force.

### SUMMARY OF THE INVENTION

Normally, when an external force is not applied to a robot, the above-described threshold value should be set so that the robot does not stop. When, for example, a force sensor is used to detect an external force, the value detected by the force sensor includes noise, and accordingly, it is preferable to set a higher threshold value to prevent the robot from stopping under the influence of the noise.

In some cases, a force sensor may detect an external force during operation of a robot while receiving vibrations of a robot arm or peripheral equipment. In such cases, setting a higher threshold value to prevent vibrations of the robot arm, etc., from stopping the robot is desired.

Further, when a robot operates while receiving a reaction force, the reaction force is included in an external force, and accordingly, the robot may easily stop in some cases. Thus, in such cases, setting a higher threshold value to prevent the reaction force from causing the robot to stop is desired.

However, when a higher threshold value is set as described above, a force to be applied to a person if the person touches a robot increases. Thus, human safety cannot be ensured in some cases.

In the meantime, when a robot is near a foreign object, a person may be sandwiched between the robot and the foreign object. In this respect, an external force exceeds a predetermined threshold value, and then a command to stop the robot is output. However, the robot first slows down and then stops. Accordingly, the robot still moves as it slows down.

In other words, when a person is sandwiched between a robot and peripheral equipment or a foreign object, if a command to stop the robot is output, the robot would not stop immediately. The robot would continue to move toward the peripheral, equipment in the slowing-down time, and then would further press the person against the peripheral equipment. Thus, a force greater than a predetermined threshold value, which is applied to the person, may put the person in danger. In such a case, it is preferable to set a lower threshold value to reduce the force applied from the robot to the person.

However, when a lower threshold value is set as described above, vibrations of an arm of a robot in motion or a foreign object may cause the robot to stop even when an external force is not actually applied. In this instance, the productivity of the robot reduces.

As described above, an optimal threshold value of an external, force varies depending on conditions. Thus, changing a threshold value while ensuring human safety, after evaluating the conditions of a robot and a person is desired.

In application of the technology disclosed in. Japanese Patent No. 5436160, when, for example, a robot receives a reaction force, inputting a command to increase a threshold value at a position immediately before the robot receives the reaction force prevents the reaction force from causing the robot to stop. Further, inputting a command to reduce the threshold value at a predetermined position before the robot approaches peripheral equipment can reduce a force applied to a person.

However, in such a case, an appropriate command should be accurately input for each action of the robot. If, for example, a false command is input or an appropriate command is not input when the robot approaches the peripheral equipment, the threshold value does not reduce. Thus, the person may be sandwiched between the robot and the peripheral equipment, and a large force corresponding to the threshold value may be applied to the person, and then the person may be put in danger. Thus, when a robot performs various actions, a method for inputting a command for each action of the robot is cumbersome and impractical, and cannot ensure human safety.

The present invention was made in light of the circumstances described above and has an object to provide a safety monitoring device for a robot, which can appropriately change a threshold value depending on conditions without inputting a command for each action of the robot.

To achieve the above object, according to a first aspect of the invention, there is provided a safety monitoring device for a robot. The safety monitoring device includes a position detecting unit for detecting the position of a robot, a force detecting unit for detecting an external force applied to the position detecting unit, an external force determination condition setting unit, which sets, as an external force determination condition, an intra-region external force determination condition when the present position of the robot detected by the position detecting unit remains within a predetermined region and which sets, as an external force determination condition, an out-of-region external force determination condition when the present position of the robot is out of the predetermined region, and a robot stopping unit for stopping the robot when the external force detected by the force detecting unit satisfies the external force determination condition.

According to a second aspect of the invention, in the safety monitoring device according to the first aspect of the invention, when the predetermined region is a region in which the robot receives a reaction force, the intra-region external force determination condition is the fact that the external force exceeds a predetermined first threshold, value, and the out-of-region external force determination condition is the fact that the external force exceeds a predetermined second threshold value smaller than the first threshold value.

According to a third aspect of the invention, in the safety monitoring device according to the first aspect of the invention, when the predetermined region is a region in which a distance between the robot and peripheral equipment is a predetermined distance or less, the intra-region external force determination condition is the fact that the external force exceeds a predetermined third threshold value, and the out-of-region external force determination condition is the fact that the external force exceeds a predetermined fourth threshold value greater than the third threshold value.

According to a fourth aspect of the invention, in the safety monitoring device according to any of the first to third aspects of the invention, wherein the external force determination condition includes at least one of the fact that the external force detected by the force detecting unit exceeds a predetermined fifth threshold value, the fact that the moving average of the external force detected by the force detecting unit exceeds a predetermined sixth threshold value, and the fact that the amount of displacement between an external force detected by the force detecting unit before a predetermined time and an external force detected by the force detecting unit at present exceeds a predetermined seventh threshold value.

According to a fifth aspect of the invention, in the safety monitoring device according to any of the first to fourth aspects of the invention, when the present position of the robot remains within the predetermined region, the robot stopping unit is invalidated.

According to a sixth aspect of the invention, in the safety monitoring device according to any of the first to fifth aspects of the invention, there is provided a speed limiting unit for restricting the upper limit of the moving speed of the robot to a predetermined speed when the present position of the robot remains within the predetermined region.

According to a seventh aspect of the invention, in the safety monitoring device according to any of the first to sixth aspects of the invention, there is provided an acceleration limiting unit for restricting the upper limit of the acceleration of the robot to a predetermined acceleration when the present position the robot remains within the predetermined region.

According to an eighth aspect of the invention, in the safety monitoring device according to any of the first to seventh aspects of the invention, the predetermined region is one of a plurality of predetermined regions.

The objects, features, and advantages of the present invention and other objects, features, and advantages will become further clear from the detailed description of typical embodiments illustrated in the appended drawings.

### BRIEF DESCRIPTION OF THE DRAWINGS

FIG. 1 is a diagram of a system including a safety monitoring device according to the present invention.

FIG. 2 is a flowchart of the operation of a safety monitoring device according to the present invention.

FIG. 3A is a first view of a robot in a second example of the present invention.

FIG. 3B is a second view of a robot in the second example of the present invention.

FIG. 3C is a third view of a robot in the second example of the present invention.

FIG. 4 is a view of still another robot.

### DETAILED DESCRIPTION

Embodiments of the present invention will be described below with reference to the accompanying drawings. In the following figures, similar members are designated with the same reference numerals. These figures are properly modified in scale to assist the understanding thereof.

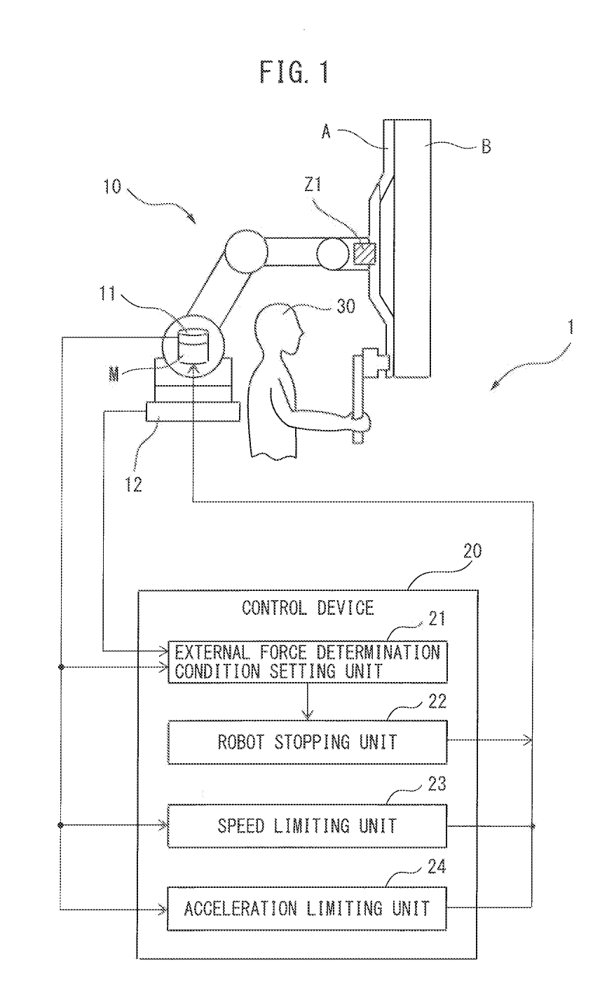

FIG. 1 is a diagram of a system including a safety monitoring device according to the present invention. As shown in FIG. 1, a system 1 includes a robot 10 and a control device 20 for controlling the robot 10.

The robot 10 is an articulated robot, and is driven by at least one driving device, for example, a servomotor M. Although FIG. 1 shows one servomotor M, the robot 10 is driven by a plurality of driving devices. Further, a position detecting unit 11, for example, an encoder is provided in one or each of a plurality of servomotors M. Each position detecting unit 11 detects the position of the robot 10, specifically, the position of the front end of the robot 10.

Further, a force detecting unit 12 for detecting an external force applied to the robot 10, for example, a six-axis force sensor is provided on the bottom of the base part of the robot 10. The force detecting unit 12 subtracts the weight of the robot 10, the weight of a workpiece grasped by the robot 10, and an inertial force generated by the motion of the robot 10 from the value detected by the force detecting unit 12, to detect an external force applied to the robot 10.

The control device 20 is a digital computer, and includes an external force determination condition setting unit 21, which sets, as an external force determination condition, an intra-region external force determination condition when the present position of the robot 10 detected by the position detecting unit 11 remains within a predetermined region and which sets, as an external force determination condition, an out-of-region external force determination condition when the present position of the robot 10 is outside of the predetermined region. Note that the predetermined region is set for each operation to be performed by the robot 10. The control device 20 also includes a robot stopping unit 22 for stopping the robot 10 when an external force detected by the force detecting unit 12 satisfies the external force determination condition.

As can be seen from FIG. 1, the control device 20 includes a speed limiting unit 23 for restricting the upper limit of the robot moving speed to a predetermined speed when the present position of the robot 10 remains within the predetermined region, and an acceleration limiting unit 24 for restricting the upper limit of acceleration in the movement of the robot to a predetermined acceleration.

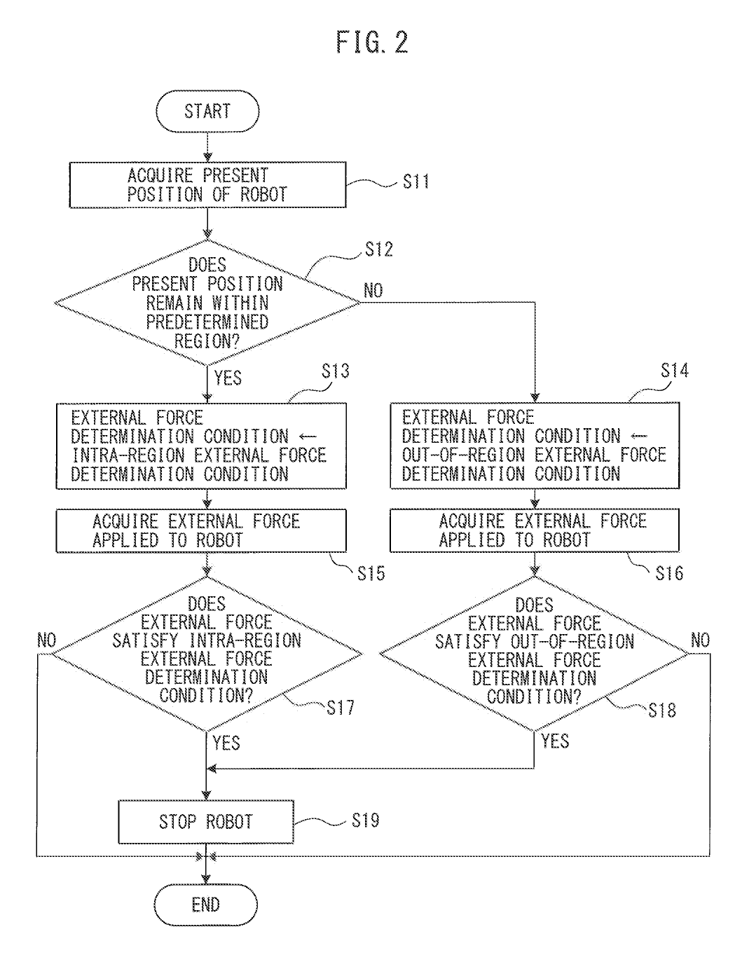

FIG. 2 is a flowchart of toe operation of a safety monitoring device according to the present invention. Note that the safety monitoring device according to the present invention includes the control device 20, the position detecting unit 11, and the force detecting unit 12. The operation of the safety monitoring device will be described below with reference to FIGS. 1 and 2. Note that the operation shown in FIG. 2 is repeated at a predetermined control interval when the robot 10 performs an operation in cooperation with a person.

A first example of the operation performed by the robot 10 is shown in FIG. 1. In FIG. 1, the robot 10 grasps a workpiece A with, for example, a hand, and presses the same against a workpiece B secured to an outside member. Then a person 30 fastens the workpiece A to the workpiece B by bolts.

As can be seen from FIG. 1, the robot 10 operates together with the person 30 in the same working area. In the first example shown in FIG. 1, there is no safety fence or the like between the robot 10 and the person 30, and accordingly, safety should be ensured to prevent the person 30 from being put in danger. The operation of the safety monitoring device in the first example will be described below.

First, in step S11 of FIG. 1, the position detecting unit 11 acquires the present position of the front end of the robot 10. First, in step S12, whether the present position of the front end of the robot 10 remains within a predetermined region is determined.

In this respect, the predetermined region in the first example corresponds to a region Z1 in FIG. 1. The region Z1 is a region having predetermined dimensions, which includes the front end of the robot 10 when The robot 10 presses the workpiece A against the workpiece B at a predetermined position. The region Z1 is determined in accordance with a positional deviation amount between the workpiece A and the workpiece B. The region Z1 is, for example, a cube including the position of the front end of the robot 10 when the robot 10 presses the workpiece A against the workpiece B at a predetermined position. A side of the cube corresponds to the positional deviation amount between the workpiece A and the workpiece B, for example, 5 mm. The positional deviation between the workpiece A and the workpiece B occurs due to, for example, the individual difference in the workpieces A and B.

When it is determined, in step S12, that the present position of the front end of the robot 10 remains within the region. Z1, the process is shifted to step S13. In step S13, a predetermined intra-region external force determination condition is set as an external force determination condition.

The intra-region external force determination condition in the first example is the fact that an external force applied to the robot 10 is not less than a first threshold value, for example, 250 N. In the first example, when the workpiece A is pressed against the workpiece B, a reaction force of approximately 200 N is applied to the robot 10. The first threshold value is a predetermined value greater than a reaction force of 200 N, for example, 250 N.

Then, in step S15, the force detecting unit 12 detects an external, force applied to the robot 10. Subsequently, in step S17, whether the external force satisfies the intra-region external force determination condition, i.e., whether the external force is not less than the first threshold value, for example, 250 N is determined. When the external force satisfies the intra region external force determination condition, the process is shifted to step S19, and the robot stopping unit 22 stops the robot. Note that, when the external force does not satisfy the intra-region external force determination condition, the process continues.

In contrast, when it is determined that the present position of the front end of the robot 10 is out of the region Z1, the process is shifted to step S14. In step S14, a predetermined out-of-region external force determination condition is set as an external force determination condition. The out-of-region external force determination condition in the first example is the fact that an external force applied to the robot 10 is not less than a second threshold value smaller than the first threshold value, for example, 50 N.

Then, in step S16, the force detecting unit 12 detects an external force applied to the robot 10. Subsequently, in step S18, whether the external force satisfies the out-of-region external force determination condition, i.e., whether an external force is not less than the second threshold value, for example, 50 N is determined. When the external force satisfies the out-of-region external force determination condition, the process is shifted to step S19, and the robot stopping unit 22 stops the robot. Note that, when the external force does not satisfy the out-of-region external force determination condition, the process continues.

While, for example, the robot 10 conveys the workpiece A, the front end of the robot 10 is outside of the region Z1, and accordingly, the out-of-region external force determination condition is set. When the person 30 touches the robot 10, and then an external force not less than the second threshold value, for example, 50 N is detected, the robot stopping unit 22 stops the robot 10. In other words, in the outside of the region Z1, even when a force applied from the robot 10 to the person 30 is relatively small, the robot 10 stops.

In contrast, while the robot 10 presses the workpiece A against, the workpiece B, the front end of the robot 10 remains within the region Z1, and accordingly, the intra-region external force determination condition is set. When the person 30 touches the robot 10, and then an external force not less than the first threshold value, for example, 250 N is detected, the robot stopping unit 22 stops the robot 10.

In this instance, the force detecting unit 12 detects a reaction force, for example, a force of 200 N. Thus, when, for example, the person 30 touches the robot 10 under the condition that a force may be applied in a direction to cancel the reaction force, and a force applied from the robot 10 to the person 30 reaches 450 N, the force detecting unit detects an external force of 230 N, and the robot stopping unit 22 stops the robot. In other words, if the worst happens, when a force applied from the robot 10 to the person 30 reaches or exceeds 450 N, the robot 10 stops.

Thus, when the front end of the robot 10 remains within the region Z1, in comparison with the case that the front end of the robot 10 is out of the region Z1, the force applied from the robot 10 to the person 30 can be quite large. However, as described above, the region Z1 is relatively small, and is, for example, a cube having a side of 5 mm. Thus, risk management for the person 30 can be easily performed.

When, for example, the front end of the robot 10 remains within the region Z1, the speed limiting unit 23 may be used to restrict the upper limit of the moving speed of the robot 10 to a relatively small predetermined speed. Thus, the force applied from the robot 10 to a person can be reduced to prevent the person from being put in danger. Note that using the speed limiting unit 23 as described above reduces the productivity of the robot 10. However, the region Z1 is small, and accordingly, the reduction of the productivity of the robot 10 occurs temporarily and partially. Thus, as a whole, the reduction of the productivity of the robot 10 is not so large.

In the above description, the force detecting unit 12 compares the resultant force of the detected external forces with the first threshold value or the second threshold value. However, a threshold value may be set for each of the x-, y-, and z-direction force components. When, for example, a reaction force is previously anticipated to be applied in a specific direction, only the threshold value in the specific direction in a predetermined region is set to be larger than threshold values in the other directions. If the threshold values in the other directions are set to be relatively small, for example, to be equal to the second threshold value of the out-of-region external force determination condition, a touch of the person 30 to the robot 10 can be detected at a high sensitivity with respect to forces in the other directions even in the predetermined region.

Note that, in the first example, when the individual difference in the shape of the workpiece A and/or the workpiece B is too large, the reaction force when the workpiece A is pressed against the workpiece B varies widely. In such a case, sufficient estimation of the first threshold value and/or the second threshold value cannot be previously performed, and accordingly, it is difficult to set an appropriate external force determination condition.

In such a case, when the front end of the robot 10 remains within the region Z1, it is preferable to invalidate the robot stopping unit 22. Thus, if the robot 10 touches, for example, the person 30 when the front end of the robot 10 remains within the region Z1, the robot 10 would not stop. However, as described above, the region Z1 is restricted, and thus, risk management is easy.

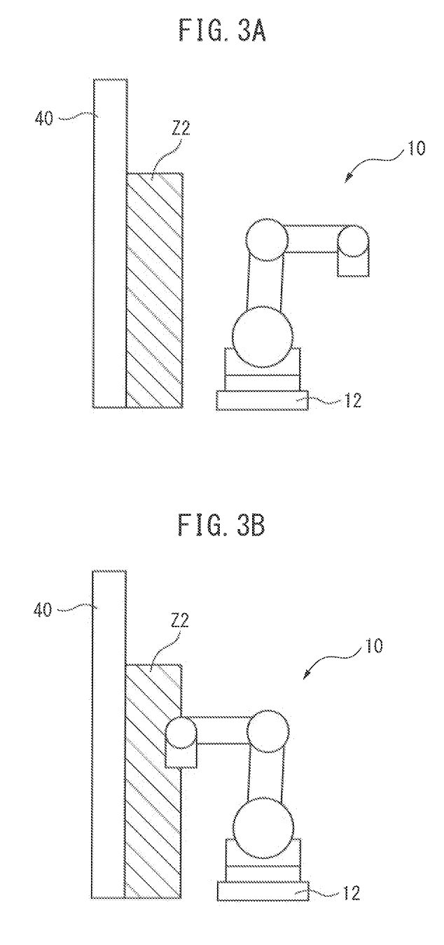

FIGS. 3A to 3C are views illustrating a robot in a second example of the present invention. In FIGS. 3A to 3C, the position detecting unit 11 and the control device 20 are not illustrated for simplicity. As shown in FIGS. 3A to 3C, in the second example, the robot 10 is disposed in the vicinity of a wall part 40 that extends vertically. Further, a region Z2 that extends, by a predetermined distance, from the wall part 40 toward the robot is illustrated. Specifically, the region Z2 is a cube having a height and a length, which are substantially equal to those of the robot 10, and a width from the wall part 40, for example, 500 mm. Alternatively, the region Z2 may be a region in which a distance between the robot 10 and peripheral equipment other than the wall part 40 is a predetermined distance or less.

In the second example, the process substantially similar to the process described with reference to FIG. 2 is performed, and accordingly, the description thereof is omitted. However, in the second example, the above-described region Z2 corresponds to the predetermined region in step S12 in FIG. 2. Further, in the second example, the intra-region external force determination condition in step S13 is the fact that an external force applied to the robot 10 is not less than a third threshold value, for example, 20 N. In the second example, the out-of-region external force determination condition in step S15 is the fact that an external force applied to the robot 10 is not less than a fourth threshold value greater than the third threshold value, for example, 50 N.

When the external force detected by the force detecting unit 12 is greater than a predetermined threshold value, a stopping command is output so that the robot 10 slows down and then stops. Thus, in the slowing-down time, the robot 10 continues to move toward the wall part 40, and accordingly, can further press a person against the wall part 40. This causes a force greater than a predetermined threshold value to be applied to the person.

Thus, it is preferable to set a lower threshold value in the region Z2, to reduce the force applied from the robot 10 to the person 30. Thus, in the second example, the third threshold value of the intra-region external force determination condition, for example, 20 N is smaller than the fourth threshold value of the out-of-region external force determination condition, for example, 50 N.

Further, in some cases, noise in the force detecting unit 12 or vibrations of the robot arm during the operation of the robot 10 cause the force detecting unit 12 to detect an external force even when any external force is not applied to the robot 10. Assuming, for example, that the force detecting unit 12 detects a force of 40 N at most in spite of the fact that no external force is applied to the robot 10, the threshold value of the external force determination condition should be larger than 40 N. This is due to the fact that, when the threshold value of the external force determination condition is not greater than 40 N, the external force detected by the force detecting unit 12 exceeds the threshold value by only the operation of the robot 10, and accordingly, the robot 10 stops.

Thus, it is necessary to set a threshold value greater than the value detected by the force detecting unit 12, for example, 40 N, which has been affected by the noise in the force detecting unit 12 or vibrations of the robot arm. Accordingly, in the second example, the fourth threshold value of the out-of-region external force determination condition, for example, 50 N is greater than 40 N.

Thus, when the front end of the robot 10 is out of the region Z2 in the second example as shown in FIG. 3A, detection of an external force not less than the fourth threshold value, for example, 50 N causes the robot stopping unit 22 to stop the robot 10. As described above, the fourth threshold value is greater than the value detected by the force detecting unit 12, for example, 40 N due to the noise in the force detecting unit 12 or vibrations of the robot arm. Thus, if the force detecting unit 12 detects a force of up to 40 N in spite of the fact that no external force is applied, the robot 10 would not stop. Accordingly, in this instance, the productivity does not reduce.

Further, when the front end of the robot 10 remains within the region Z2 in the second example as shown in FIG. 3B, the person 30 (not shown) can be sandwiched between the robot 10 and the wall part 40. Detection of an external force greater than the third threshold value, for example, 20 N causes the robot stopping unit 22 to slow down and then stop the robot 10. As described above, the third threshold value is smaller than the fourth threshold value, for example, 40 N. Thus, in comparison with the case that the person 30 is sandwiched as described above while the fourth threshold value is adopted, the possibility that the person 30 may be put in danger can be reduced.

Further, in the region Z2, when an external force greater than the third threshold value, for example, 20 N is detected, the robot stopping unit 22 stops the robot under the effect of the noise in the force detecting unit 12 or vibrations of the robot arm. Thus, the productivity may reduce.

However, the region Z2 itself is restricted, and accordingly, managing the robot 10 to prevent the productivity from reducing is easy. For example, in the region Z2, the acceleration limiting unit 24 may restrict the acceleration of the robot 10. This eliminates, for example, a component affected by vibrations of the robot arm from the external force detected by the force detecting unit 12. Accordingly, the external force detected by the force detecting unit 12 is reduced. Thus, there is no possibility that the force detected by the force detecting unit 12 is greater than the third threshold value in spite of the fact that no external force is applied in the region Z2. Thus, the robot 10 is prevented from stopping.

In general, when the robot 10 stops, a lot of time is required to restart the robot. However, in the present invention, limiting the acceleration of the robot 10 prevents the robot 10 from stopping. This prevents the productivity from reducing.

Alternatively, the operation program of the robot 10 may be changed to minimize the time for which the front end of the robot 10 remains within the region Z2. This prevents the productivity from reducing. In this respect, a mistake in change of the operation program may cause the robot 10 to accidentally approach the wall part 40. However, even in such a case, the third threshold value as an intra-region external force determination condition is small, and accordingly, the risk for the person 30 is small. Thus, the person 30 can perform, for example, a teaching operation without regard to the risk.

In the meantime, in the above embodiments, depending on whether the front end of the robot 10 is included in the region Z2, whether the present position of the robot 10 remains within the region Z2 is determined. However, as shown in FIG. 3C, even when the front end of the robot 10 is outside of the region Z2, a part of the robot 10 can be located in the region Z2.

In this instance, the front end of the robot 10 is outside of the region Z2, and accordingly, the out-of-region external force determination condition is set. Accordingly, even when the person 30 is sandwiched between a part of the robot 10 and the wall part 40, the robot 10 would not stop unless the external force detected by the force detecting unit 12 exceeds the fourth threshold value, for example, 40 N. Accordingly, even when it is determined that only a part of the robot 10 remains within the region Z2, it is preferable that the intra-region external force determination condition is set as an external force determination condition. In other words, in step S12, it is preferable to determine whether at least a part of the robot 10 remains within the region Z2.

As described above, the external force determination condition includes the intra-region external force determination condition or the out-of-region external force determination condition. In another embodiment, the external force determination condition may include at least another condition. Another such condition is, for example, the fact that an external force detected by the force detecting unit 12 is not less than a predetermined fifth threshold value, for example, 50 N. This enables accurate detection of the application of an external force to the robot 10.

Alternatively, another such condition is the fact that the moving average of an external force detected at a predetermined time, for example, 0.1 sec. is not less than a predetermined sixth threshold value, for example, 50 N. In this instance, after the effect of noise included in the value detected by the force detecting unit 12 is eliminated, the application of an external force to the robot 10 can be determined.

In the meantime, when the robot 10 collides with a foreign object, for example, the wall part 40, an external force detected by the force detecting unit 12 continues changing for the time from when the robot 10 starts touching the foreign object to when the robot stopping unit 22 stops the robot 10. Note that the change in the external force varies depending on the speed of the robot 10, the composition of the foreign object, etc. It is preferable that the time from when the robot 10 starts touching the foreign object to when the robot stopping unit 22 stops the robot 10 be short.

When an external, force changes rapidly, the application of the external force to the robot can be, in some cases, more rapidly confirmed by determination based on the amount of displacement of the external force than by determination based on the magnitude of the external force. Thus, as another condition as described above, the fact that the amount of displacement between the external force detected by the force detecting unit 12 before a predetermined time, for example, 0.1 sec. and the present external force detected by the force detecting unit 12 is not less than a predetermined seventh threshold value, for example, 20 N may be adopted.

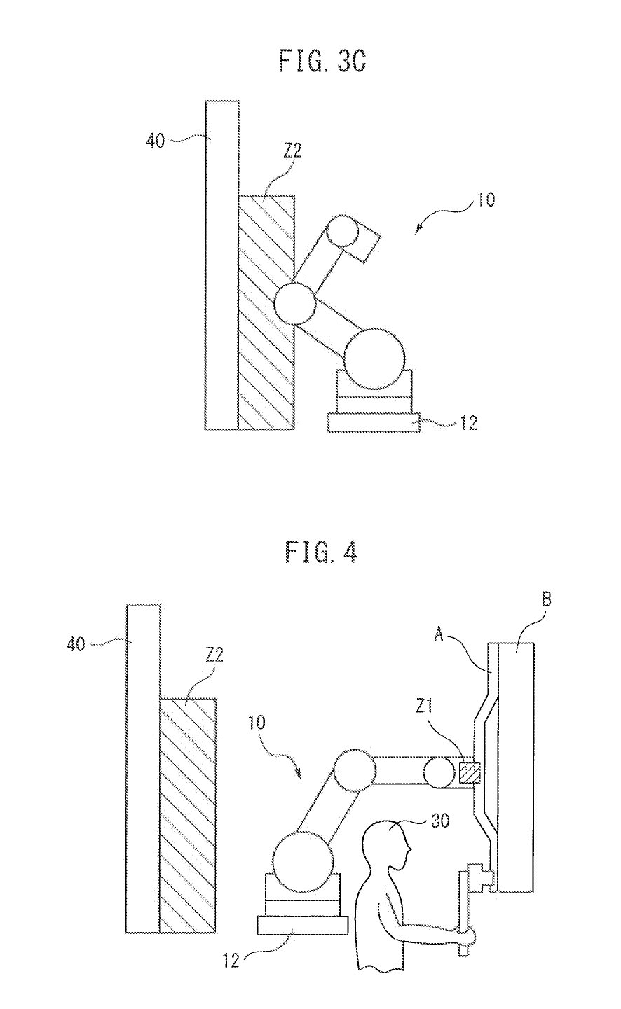

FIG. 4 is a view illustrating still another robot in a third example. In FIG. 4, the position detecting unit 11 and the control device 20 are not illustrated for simplicity. In FIG. 4, both the region Z1 and the region Z2 are illustrated. In such a case, whether the front end of the robot 10 remains within either the region Z1 or the region Z2, or whether the same is outside of both regions is first determined.

When it is determined that the front end of the robot 10 remains within the region Z1, a predetermined external force determination condition for the region Z1, for example, the fact that an external force is not less than the first threshold value, for example, 250 N is selected, and then the process is performed as described above based on the selected condition. Likewise, when it is determined that the front end of the robot 10 remains within the region Z2, a predetermined external force determination condition for the region Z2, for example, the fact that an external force is not less than the third threshold value, for example, 20 N is selected, and then the process is performed as described above based on the selected condition. Further, when the front end of the robot 10 is outside of both regions, the fact that a threshold value of a predetermined out-of-region external force determination condition is less than, for example, 50 N is selected, and then the process is performed as described above based on the selected condition.

Even in such a case, the fact that effects similar to the above effects can be obtained would be obvious. Note that, in some embodiments, three or more regions may be set, and different external force determination conditions may be set for the corresponding conditions.

As the number of set regions increases, the possibility that a person for teaching the robot 10 can teach the robot 10 without worry about safety increases.

### Effect of the Invention

In the first to third aspects of the invention, in a region in which a robot operates while receiving a reaction force, a higher threshold value of an external force is set as an external force determination condition, and in the outside of such a region, a lower threshold value of an external force is set. Thus, in the outside of the region in which a robot operates while receiving a reaction force, the possibility that a person may be put in danger can be reduced.

Further, in a region in which a robot is disposed in the vicinity of peripheral equipment, a lower threshold value of an external force is set as an external force determination condition, and in the outside of such a region, a higher threshold value of an external force is set. Thus, in the region in which the robot is disposed in the vicinity of peripheral equipment, the possibility that a person may be sandwiched between the robot and the peripheral equipment can be reduced.

Further, the threshold value as an external force determination condition is changed based on the present position of the robot, and accordingly, it is not necessary to input a command for each action of the robot. Thus, the threshold value can be changed depending on the conditions without a cumbersome operation to input commands.

In the fourth aspect of the invention, an appropriate external force determination condition can be set.

In the fifth aspect of the invention, it is advantageous when an appropriate threshold value cannot be previously prepared.

In the sixth aspect of the invention, a speed limiting unit can reduce the possibility that a person may be put in danger.

In the seventh aspect of the invention, an acceleration limiting unit can prevent the productivity from reducing.

In the eighth aspect of the invention, setting an external force determination condition for each of a plurality of regions can further ensure human safety.

The present invention has been described above using exemplary embodiments. However, a person skilled in the art would understand that the aforementioned modifications and various other modifications, omissions, and additions can be made without departing from the scope of the present invention.

What is claimed is:

1. A safety monitoring device for a robot, comprising:
a position detecting unit for detecting the position of a robot;
a force detecting unit for detecting an external force applied to the position detecting unit:
an external force determination condition setting unit, which sets, as an external force determination condition, an intra-region external force determination condition when the present position of the robot detected by the position detecting unit remains within a predetermined region and which sets, as an external force determination condition, an out-of-region external force determination condition when the present position of the robot is outside of the predetermined region; and
a robot stopping unit for stopping the robot when the external force detected by the force detecting unit satisfies the external force determination condition,

2. The safety monitoring device according to claim 1, wherein, when the predetermined region is a region in which the robot receives a reaction force, the intra-region external force determination condition is the fact that the external force exceeds a predetermined first threshold value, and the out-of-region external force determination condition is the fact that the external force exceeds a predetermined second threshold value smaller than the first threshold value.

3. The safety monitoring device according to claim 1, wherein, when the predetermined region is a region in which a distance between the robot and peripheral equipment is a predetermined distance or less, the intra-region external force determination condition is the fact that the external force exceeds a predetermined third threshold value, and the out-of-region external force determination condition is the fact that the external force exceeds a predetermined fourth threshold value greater than the third threshold value.

4. The safety monitoring device according to claim 1, wherein the external force determination condition includes at least one of the fact that the external force detected by the force detecting unit exceeds a predetermined fifth threshold value, the fact that the moving average of the external force detected by the force detecting unit exceeds a predetermined sixth threshold value, and the fact that the amount of displacement between an external force detected by the force detecting unit before a predetermined time and an external force detected by the force detecting unit at present exceeds a predetermined seventh threshold value.

5. The safety monitoring device according to claim 1, wherein, when the present position of the robot remains within the predetermined region, the robot stopping unit is invalidated.

6. The safety monitoring device according to claim 1, comprising a speed limiting unit for restricting the upper limit of the moving speed of the robot to a predetermined speed when the present position of the robot remains within the predetermined region.

7. The safety monitoring device according to claim 1, comprising an acceleration limiting unit for restricting the upper limit of the acceleration of the robot to a predetermined acceleration when the present position of the robot remains within the predetermined region.

8. The safety monitoring device according to claim wherein the predetermined region is one of a plurality of predetermined regions.
